(19) United States
(12) Patent Application Publication
(10) Pub. No.: US 2004/0247024 A1
(43) Pub. Date: Dec. 9, 2004

(54) Techniques to perform line qualification

(76) Inventors: Xiao M. Gao, Raleigh, NC (US); Wesley H. Smith, Raleigh, NC (US); Chunming Han, Manalapan, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/457,092

(22) Filed: Jun. 6, 2003

(51) Int. Cl. H04B 1/38

(52) U.S. Cl. 375/222

(57) ABSTRACT

Briefly, a system that may perform line qualification within a mass-manufacturable modem.

### FIELD

The subject matter disclosed herein generally relates to techniques to testing signal propagation media.

### DESCRIPTION OF RELATED ART

Line qualification can determine whether a signal propagation medium is capable of providing communications in accordance with a particular communications standard. For example, line qualification can be performed to determine whether a signal propagation medium can be used with DSL standards and variations thereof (including but not limited to ADSL, SHDSL, and VDSL) (DSL standards and variations thereof hereafter are referred to as xDSL). For a description of xDSL standards, see, for example, ITU-T G.991.1, High bit rate Digital Subscriber Line T transceivers (1998); ITU-T G.991.2, Single-pair high-speed Digital Subscriber Line transceivers (2001); and ITU-T G.992.1 (1999) and related standards. Current DSL and ADSL line qualification techniques typically use dedicated and very expensive hardware and can involve an expensive procedure of dispatching of a trained technician to the client modem site. Currently, it is impractical to build line qualification systems inside cost-sensitive DSL and ADSL mass production modems.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts in block diagram format a communications system in accordance with an embodiment of the present invention;

FIG. 2 depicts one possible implementation of a modem in accordance with an embodiment of the present invention; and

FIG. 3 depicts a process that may be performed by a controller.

Note that use of the same reference numbers in different figures indicates the same or like elements.

### DETAILED DESCRIPTION

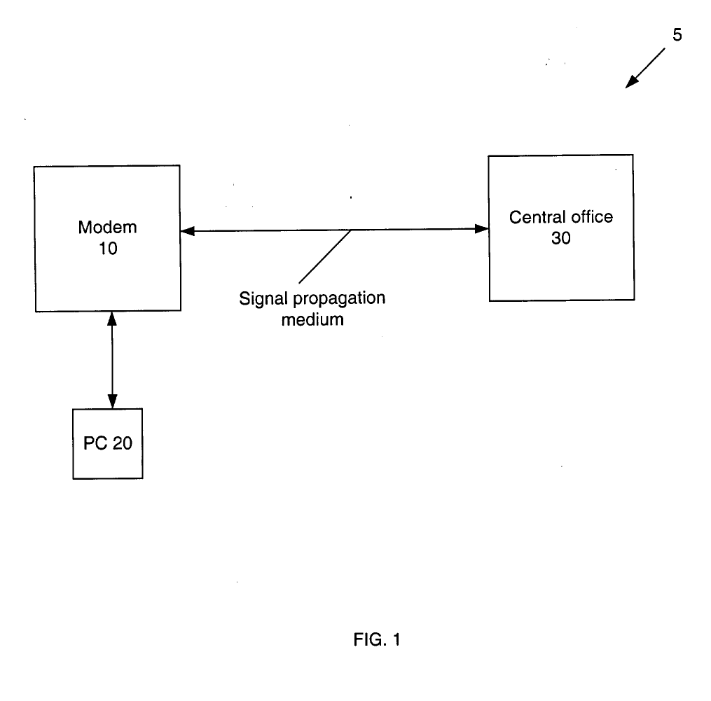

FIG. 1 depicts in block diagram format a communications system 5. Modem 10 may provide communications between a personal computer (PC) 20 and a central office modem 30 using a communications medium such as a twisted pair telephone line, coaxial cable, fiber optic cable, or wireless techniques. Modem 10 may provide communications capabilities in accordance, for example, with xDSL and/or other protocols

Modem 10 may communicate with PC 20 using a cable or bus compliant, for example, with Peripheral Component Interconnect (PCI), Universal Serial Bus (USB), Ethernet (e.g., IEEE 802.3), and/or IEEE 1394, although other techniques may be used such as wireless techniques described, for example, in IEEE 802.11 (and related standards).

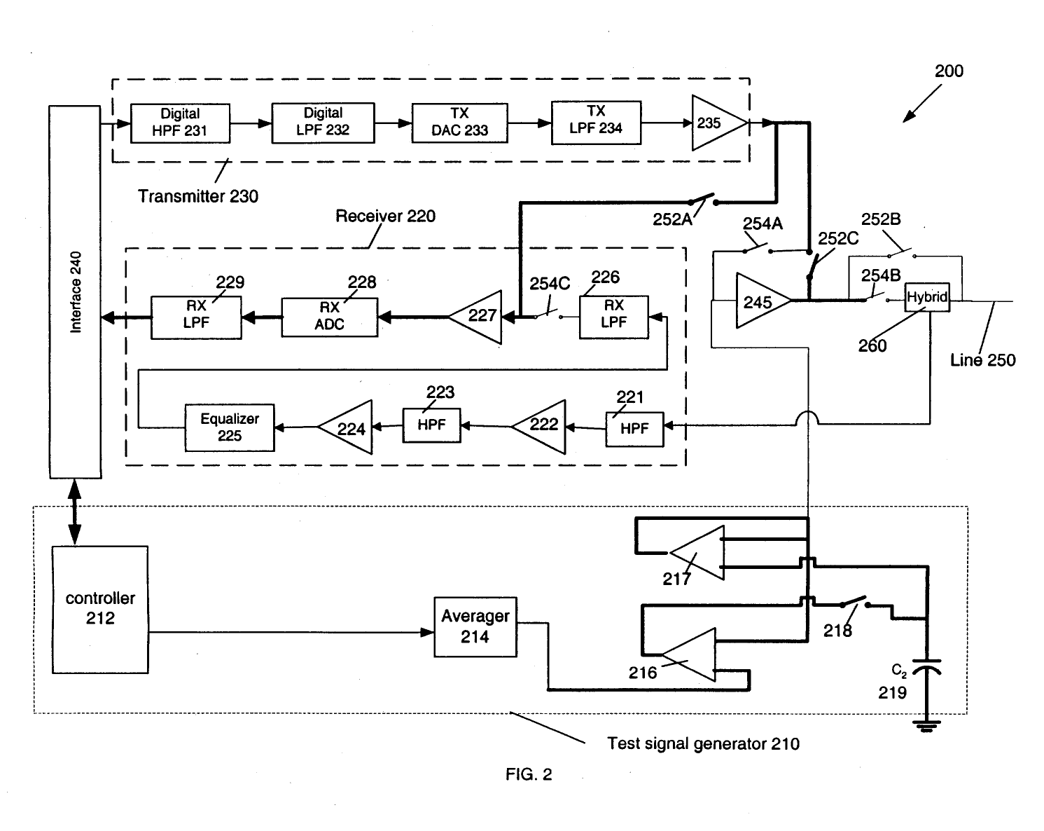

FIG. 2 depicts one possible implementation of a modem 200 in accordance with an embodiment of the present invention, although other implementations may be used. In accordance with an embodiment of the present invention, modem 200 may perform line qualification of a line, such as one or a combination of a twisted pair telephone line, coaxial cable, or other signal propagation medium, to determine whether the line is capable of providing xDSL or other communications services. Modem 200 may at least perform line qualification of lines of different lengths and having one or more bridge taps. For example, a bridge tap may represent a juncture in which another modem or device may access the line. To perform line qualification, modem 200 may transmit test signals to the line and process signals reflected by the line in response to the test signals.

One embodiment of modem 200 may include test signal generator 210, receiver 220, transmitter 230, interface 240, line driver 245, hybrid 260, and switches 252A, 252B, 252C and 254A, 254B, and 254C, although other implementations may be used. Modem 200 may be implemented as any or a combination of: hardwired logic, software stored by a memory device and executed by a microprocessor, firmware, an application specific integrated circuit (ASIC), and/or a field programmable gate array (FPGA). In one implementation, one advantage, although not a necessary feature, is that line qualification capabilities may be manufactured using cost-effective analog front end devices.

Modem 200 may communicate with a far end modem or other device using line 250. Modem 200 may operate in line qualification mode and modem mode. In line qualification mode, modem 200 may operate in “transmit” and “receive” modes. In “transmit” and “receive” line qualification modes, switches 252A-252C may be set to close (i.e., transfer signals) and switches 254A-254C may be set to open (i.e., to not transfer signals). During “transmit” line qualification mode, test signals transmitted by test signal generator 210 to line 250 may traverse line driver 245 and closed switch 252B. Such test signals may bypass hybrid 260 and may avoid introducing board echo attributable to the hybrid 260.

In “receive” line qualification mode, a reflection signal from line 250 based on a test signal transmitted in “transmit” line qualification mode may be transferred by closed switch 252B, closed switch 252C, and closed switch 252A to amplifier 227. Accordingly, modem 200 may route reflection signals during “receive” line qualification mode to bypass the high pass filter 221 and thereby avoid associated frequency cut off from the high pass filter 221.

In one implementation, if line qualification passes, then modem 200 may operate in modem mode. When the modem 200 operates in modem mode, switches 254A-254C may be set to close (i.e., transfer signals) and switches 252A-252C may be set to open (i.e., not transfer signals). To transmit signals in modem mode, transmitter 230 may transmit signals to line 250 through closed switch 254A, line driver 245, closed switch 254B, and hybrid 260. To receive signals during modem mode, high pass filter 221 of receiver 220 may receive signals from hybrid 260 and closed switch 254C may transfer received signals from LPF 226 to amplifier 227. Additional description of receiving signals during modem mode is provided with respect to description of receiver 220.

One implementation of test signal generator 210 may include controller 212, averager 214, first amplifier 216, second amplifier 217, first switch 218, and capacitive element 219, although other implementations may be used. Based on amplitude and duration controls from controller 212, test signal generator 210 may provide test signals for use in line qualification of line 250. For example, a test signal may be a pulse with amplitude and duration programmed by controller 212. Based on signals reflected by the line 250 in response to the test signals, controller 212 may modify the duration and/or amplitude of the test signals or determine whether line qualification has passed.

As described earlier, the open/close states of switches 252A-252C and 254A-254C may control the path of test signals transmitted by test signal generator 210 during “transmit” line qualification mode as well as the path of reflected signals based on the test signals during “receive” line qualification mode. In one implementation, controller 212 may control the open/close states of switches 252A-252C and 254A-254C during line qualification and modem modes.

Based on signals reflected by line 250 in response to test signals, controller 212 may determine characteristics of the line (such as the length of the line, whether a bridge tap exists in the line, and cross talk noise level) and whether the line passes line qualification for xDSL or other services. The length of the line may be an important factor in whether the line passes line qualification for xDSL service although other factors may be considered such as the existence and distance of any bridge taps in the line and cross talk noise level. For example, controller 212 may use time domain reflectometry (TDR) techniques to determine the length of line 250. Controller 212 may indicate to interface 240 that the line passes or fails line qualification for xDSL or another service. In one implementation, controller 212 may be implemented as software executed for example by PC 20 or a central processing unit of modem 200 (not depicted).

In one implementation, to control the amplitude and duration of test signals transmitted during both “transmit” and “receive” line qualification modes, controller 212 may control averager 214 and the open/close state of first switch 218. To transmit a test signal, controller 212 may provide one or more binary pulses to averager 214. Averager 214 may output a signal having an amplitude that is an average (over time) of multiple pulse signals from controller 212. Averager 214 may be implemented as an integrator. The average amplitude output signal from averager 214 as well as the open/closed state of switch 218 may control the amplitude and duration of test signals transmitted by test signal generator 210. For example, when switch 218 is closed (i.e., switch 218 transfer signals), the amplitude of the test signal may vary according to the average amplitude output signal from averager 214. However, when switch 218 is open (i.e., switch 218 does not transfer signals), the amplitude of a test signal may be held at approximately the same level as when the switch 218 changed from closed to open states.

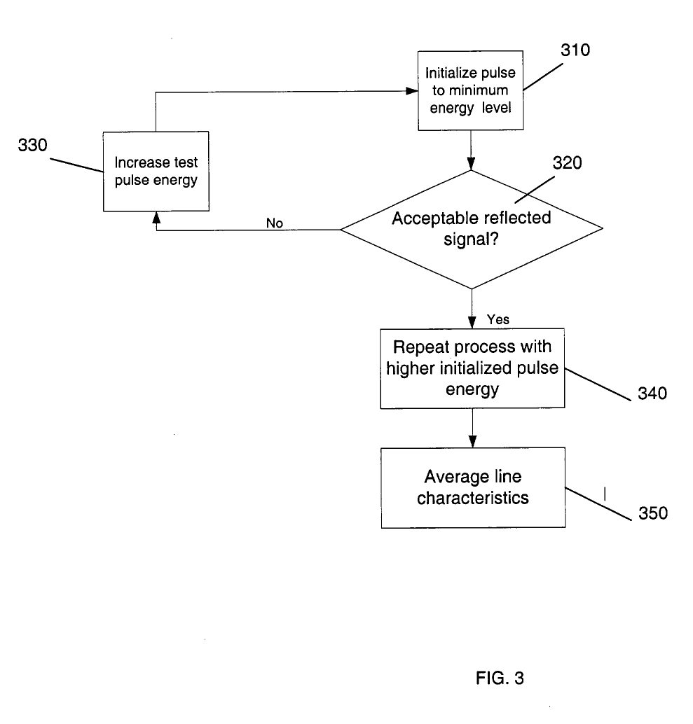

For example, FIG. 3 depicts a process that may be performed by test signal generator 210 to determine a length of the line 250 during line qualification. The length of the line 250 may be an important factor in whether the line passes line qualification for xDSL or some other service. In action 310, controller 212 may initialize the energy of the test signal to a minimum initial level. For example, energy may be defined as the amplitude times the duration of the test signal. In action 320, controller 212 may determine whether a time interval between the transmission of the test signal and receipt of the reflection signal passes a specified threshold and whether an amplitude of the reflection signal exceeds a specified threshold. If both conditions are met, then action 340 may follow action 320. If both conditions are not met, then action 330 may follow action 320. In action 330, controller 212 may increase the energy of the test signal. For example, when the test signal is a pulse, the amplitude may be held constant and the duration increased. In action 340, controller 212 may repeat the actions 310 and 320 multiple times for increasing test signal energy levels. Action 340 may determine multiple time intervals between the transmission of a test signal and receipt of a reflection signal. In action 350, controller 212 may average the multiple time intervals from action 340. For example, controller 212 may determine the length of the line by averaging multiple time intervals between the transmission of the test signal and receipt of the reflection signal.

Referring to FIG. 2, interface 240 may receive signals from receiver 220 and transfer signals to transmitter 230. Interface 240 may transfer signals to and from a personal computer (PC) (not depicted). Interface 240 may transfer signals to and from a controller 212. For example, interface 240 may transfer signals reflected by line 250 to controller 212 and to the PC. For example, interface 240 may transfer a message from controller 212 that the line passes 250 or fails line qualification.

During line qualification and modem modes, receiver 220 may process received signals in compliance, for example, with xDSL standards although other standards may be complied with. Received signals may be transmitted by a far end modem or central office via a bridge tap or be a reflection of a transmitted test signal. Receiver 220 may provide processed signals to interface 240 for transfer to controller 212 or some other device such as a PC. One implementation of receiver 220 may include high pass filter (HPF) 221, first line driver 222, second high pass filter (HPF) 223, second line driver 224, equalizer 225, low pass filter (LPF) 226, amplifier 227, receiver analog-to-digital converter (ADC) 228, and second low pass filter (LPF) 229, although other implementations may be used.

During “receive” line qualification mode, amplifier 227 of receiver 220 may receive reflected signals, thereby bypassing elements 221-226 of receiver 220. One advantage, although not a necessary feature, is that distortion of reflected signals by elements 221-226 of receiver 220 may be avoided by bypassing such elements. During “receive” modem mode, receiver 220 may receive signals using HPF 221 from hybrid 260.

HPF 221 may be implemented as a high pass filter having a band pass of approximately 180 kHz. First line driver 222 may receive filtered signals from HPF 221. First line driver 222 may provide a voltage gain in the range of approximately −9 to 9 dB. Second HPF 223 may receive signals from first line driver 222. Second HPF 223 may be implemented as a high pass filter having a band pass of approximately at least 180 kHz.

Second line driver 224 may receive filtered signals from second HPF 223. Second line driver 224 may provide a voltage gain in the range of approximately 0 to 30 dB. Equalizer 225 may receive signals from second line driver 224. Equalizer 225 may shorten the impulse response characteristic of line 250. LPF 226 may receive signals from equalizer 225. LPF 226 may be implemented as a low pass filter having a band pass range of approximately DC to approximately 552 or 1104 kHz. During “receive” modem mode, amplifier 227 may receive filtered signals from LPF 226 through closed switch 254C, but, during “receive” line qualification mode, amplifier 227 may receive reflected signals through switch 252A. Amplifier 227 may provide a voltage gain in the range of approximately 0 to 9 dB. ADC 228 may receive signals from amplifier 227. ADC 228 may convert signals from analog to digital formats. Second LPF 229 may receive signals from ADC 228. Second LPF 229 may be implemented as a digital low pass filter having a pass band of approximately DC to approximately 552 or 1104 kHz. Second LPF 229 may provide signals to interface 240.

In one implementation, controller 212 may program the characteristics (e.g., gain, pass band, on/off state) of each of the components of the receiver 220. In one implementation, controller 212 may reduce the effects of LPF 229 and other devices on the reflected signals by performing signal processing on the signals processed by LPF 229 and other devices.

Transmitter 230 may be used during “transmit” modem mode to transmit signals to line 250. Transmitter 230 may process signals for transmission to a far end modem or central office in compliance, for example, with xDSL standards. Interface 240 may transfer signals to transmitter 230 from an external device such as a PC or router. One implementation of transmitter 230 may include digital high pass filter (HPF) 231, digital low pass filter (LPF) 232, digital-to-analog converter (DAC) 233, second low pass filter (LPF) 234, and line driver 235, although other implementations can be used.

HPF 231 may receive signals from interface 240. HPF 231 may be implemented as a digital high pass filter having a pass band of approximately at least 25 kHz. LPF 232 may receive signals from HPF 231. LPF 232 may be implemented as a digital low pass filter having a pass band of approximately DC to approximately 138 kHz. DAC 233 may receive signals from LPF 232. DAC 233 may implemented as a conventional digital-to-analog converter. LPF 234 may receive signals from DAC 233. LPF 234 may be implemented as an analog filter having a pass band from approximately DC to 138 kHz. Line driver 235 may receive signals from LPF 234. Line driver 235 may provide a voltage gain of approximately 15.7 dB. Line driver 235 may provide signals to hybrid 260 for transmission to a far end modem or other device by way of closed switch 254A, line driver 245, and closed switch 254B.

In one implementation, controller 212 may program the characteristics (e.g., gain, pass band, on/off state) of each of the components of transmitter 230.

Modifications

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An apparatus comprising:
a test signal generator to provide a test signal and selectively transfer the test signal using a first signal route to a line-under-test in response to line qualification mode;
a receiver to receive a reflected signal from the line-under-test, wherein the reflected signal comprises a signal reflected by the line-under-test in response to the test signal, wherein the receiver selectively uses a second signal route to route the reflected signal in response to line qualification mode, and wherein the second signal route avoids processing by at least one component of the receiver; and
a transmitter to transmit signals to the line-under-test in modem mode.

2. The apparatus of claim 1, wherein the first signal route comprises a route to bypass a hybrid line interface element.

3. The apparatus of claim 1, wherein the second signal route comprises a route to bypass a hybrid line interface element and wherein the at least one component comprises a filter.

4. The apparatus of claim 1, wherein:
the receiver is to selectively receive a received signal from the line-under-test using a third signal route in response to modem mode, and
the third signal route includes the second signal route and the avoided at least one component.

5. The apparatus of claim 1, wherein the test signal generator comprises:
a controller to selectively control signal routes of the test signal and the reflected signal in response to line qualification mode.

6. The apparatus of claim 5, wherein the controller is to selectively control signal routes of a transmitted signal and received signal in response to modem mode.

7. The apparatus of claim 1, wherein the test signal generator is to selectively modify the energy of the test signal based, in part, on the reflected signal.

8. The apparatus of claim 1, wherein the test signal generator comprises a controller to determine a length of the line-under-test based on the test signals and reflected signals.

9. The apparatus of claim 8, wherein the controller is configured to determine whether the line-under-test passes line qualification, in part, on the length of the line-under-test.

10. The apparatus of claim 1, further comprising a line interface device to couple the line-under-test to the receiver and the transmitter.

11. The apparatus of claim 10, wherein the line interface comprises a hybrid device.

12. A method comprising:
selectively transferring a test signal using a first signal route to a line-under-test in response to line qualification mode;
receiving a reflected signal from the line-under-test, wherein the reflected signal comprises a signal reflected by the line-under-test in response to the test signal, wherein the receiving selectively uses a second signal route to route the reflected signal in response to line qualification mode, and wherein the second signal route avoids processing by at least one component;
selectively receiving a received signal from the line-under-test using a third signal route in response to modem mode, wherein the third signal route includes the second signal route and the avoided at least one component; and
selectively transmitting signals to the line-under-test using a fourth signal route in response to modem mode.

13. The method of claim 12, wherein the first signal route comprises a route to bypass a hybrid line interface element.

14. The method of claim 12, wherein the second signal route comprises a route to bypass a hybrid line interface element and wherein the at least one component comprises a filter.

15. The method of claim 12, further comprising selectively modifying the energy of the test signal based, in part, on the reflected signal.

16. The method of claim 12, further comprising determining a length of the line-under-test based on the test signals and reflected signals.

17. The method of claim 16, further comprising determining whether the line-under-test passes line qualification, in part, on the length of the line-under-test.

18. The method of claim 12, wherein the first and second signal routes are different.
